(19) United States
(12) Patent Application Publication
(10) Pub. No.: US 2010/0003030 A1
(43) Pub. Date: Jan. 7, 2010

(54) OPTIMISATION OF PASSIVE OPTICAL NETWORKS

(76) Inventors: Timothy H. Gilfedder, Ipswich (GB); Anthony S. Conway, Woodbridge (GB); Raphael JH Dorne, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/293,903

(22) PCT Filed: Mar. 14, 2007
(86) PCT No.: PCT/GB07/00884

§ 371 Date: Sep. 22, 2008

(30) Foreign Application Priority Data
Mar. 24, 2006 (EP) 06251613.3

(51) Int. Cl. H04J 14/00

(52) U.S. Cl. 398/67

(57) ABSTRACT

The present invention relates to communications network design, and in particular the use of passive optical networks (PONs) for optimising an existing large network infrastructure such as a backhaul network. The present invention provides a computer implemented method of designing a PON based network, the method comprising: receiving data representing a plurality of network nodes having cable interconnection routes; determining a combination of core nodes from the network nodes, the core nodes being selected by allocating a combined cost to a series of core node combinations and selecting the lowest combined cost core node combination, the combined cost of each core node combination comprising a cost allocated for each of a number of core node selection criteria; allocating a number of network nodes to each core node in the selected core node combination; for each core node in the selected core node combination, determining a combination of PONS having respective cable interconnection routes for servicing the respective allocated nodes from the core node, the PONS being selected by allocating a combined cost to a series of PON combinations and selecting the lowest combined cost PON combination, the combined cost of each PON combination comprising a cost allocated to each PON within the respective combination for each of a number of PON selection criteria; and outputting data representing each of the lowest cost PON combinations.

### FIELD OF THE INVENTION

The present invention relates to communications network design, and in particular the use of passive optical networks (PONs) for optimising an existing large network infrastructure such as a backhaul network.

### BACKGROUND OF THE INVENTION

Traditionally backhaul or intermediate networks between a number of access networks and a core or backbone network have been implemented using SONET/SDH rings or point-to-point optical links to couple the access network exchange nodes to points-of-presence or core nodes in the core network. This is due in part to the nature of the network of fibre or cable connecting these nodes which forms a mesh of connections often with each or many of the nodes connected to many of the other nodes within the network. However access networks are increasingly being implemented as passive optical networks (PONS) where possible, which suits the nature of access nodes which tend to be provided from a single head-end node out to a plurality of peripheral nodes or end users such as buildings, suburban streets or academic, business or industrial campuses. PONS offer the ability to provide improved fibre utilisation from the use of passive optical splitters that aggregate traffic for multiple users and hence reduces the cost of fibre installation and use per customer.

There is also increasing interest in extending PONS type networks from the access network users to the core nodes of the backbone network. The possibility of implementing such extended PONS networks is being driven by expectations in technology advances in this area and in particular increased distances over which PONS can operate to include the scale of distances involved in backhaul networks (for example 60 km) as compared with access networks (for example 15 km). However the current copper-based access network is a regime where individual customers are served on a one-to-one basis with the operator and no (or at least very little) aggregation of traffic or services is made. The backhaul or outer core network collects traffic from each local exchange and transports this traffic back to one or more core nodes. Each link could be carrying the combined traffic from multiple nodes and hence represents many different customers and as a result the network technology must offer reliability and management functionality far superior to access systems as a failure could affect a great many customers simultaneously. By extending PON technology into the backhaul network the intrinsic reliability of the equipment must be improved as must the associated management systems and processes.

### SUMMARY OF THE INVENTION

The present invention provides a computer implemented method of designing a PON based network, and which can be used to generate data representing a plurality of PONS in order to server a number of network nodes interconnected by existing or planned cable routes. For example a backhaul or other network design or parameters based on PON technology can then be applied to existing or planned equipment locations and cable routes. The method provides an optimum or low cost design based on a number of categories related to PON technology constraints. The method initially determines a combination of core nodes from the network nodes, the core nodes being selected by allocating a combined cost to a series of core node combinations and selecting the lowest combined cost core node combination, the combined cost of each core node combination comprising a cost allocated for each of a number of core node selection criteria. The cost is a cost parameter or value which can be defined, and represents whether each combination is a good solution or not in terms of some core node selection criteria such as the total number of code nodes in the combination and the distance along respective cable interconnection routes between each network node and a serving core node. The method then allocates a number of network nodes to each core node in the selected core node combination. This may be based on assigning each network node to the closest core node using the available cable interconnection routes. Then, for each core node in the selected core node combination, the method determines a combination of PONS having respective cable interconnection routes for servicing the respective allocated nodes from the core node, the PONS being selected by allocating a combined cost to a series of PON combinations and selecting the lowest combined cost PON combination, the combined cost of each PON combination comprising a cost allocated to each PON within the respective combination for each of a number of PON selection criteria. Examples of PON selection criteria include the total number of PONS for each core node; the total equipment required; and whether the power budget of each network node is met.

The data representing the existing network including network node locations and cable interconnection routes or available fibre runs may be stored in a database describing the architecture and equipment, and this may be supplied automatically to the method which outputs data representing each of the lowest cost PON combinations. This output data may be written to another database describing an optimum PON based design for the current network resources.

By using a two-part design method—that is first determining core nodes and then determining PONS for each core node—a manageable computing problem can be implemented despite the size of practical networks (perhaps thousands of nodes each with numerous interconnections to other nodes) and the huge combinations of factors and variables that should be taken into account. The method also provides an efficient use of computing resources given that core node solutions which are not valid are “weeded” out early on before the PON design steps for the “successful” combination.

In an embodiment, heuristic search methods are used to find optimum solutions using reasonable computing resources and processing time.

There is also provided apparatus for designing a PON based network for a plurality of network nodes having cable interconnection routes. The cable interconnection routes may be actual or planned fibre runs intersecting the nodes which are geographical locations which may include interconnections equipment and other network related equipment. The apparatus comprise means for determining a combination of core nodes from the network nodes, the core nodes being selected by allocating a combined cost to a series of core node combinations and selecting the lowest combined cost core node combination, the combined cost of each core node combination comprising a cost allocated for each of a number of core node criteria; means for allocating a number of network nodes to each core node in the selected core node combination; and means for determining a combination of PONS for servicing the respective allocated network nodes to each respective selected core node, the PONS for each core node being selected by allocating a combined cost to a series of PON combinations and selecting the lowest combined cost PON combination, the combined cost of each PON combination comprising a cost allocated to each PON within the respective combination for each of a number of PON criteria.

The series of core node combinations and PON combinations may be determined according to respective heuristic search algorithms applied to the respective total core node combinations and the total PON combinations for each core node. Example heuristic search algorithms include simulated annealing and TABU search.

In an embodiment the first core node combination in the respective (heuristic search) series is a random combination of core nodes and the first PON combination in the respective series for each core node comprises a number of predetermined PONS.

In an embodiment the core node selection criteria comprise the distance from each network node to a core node using one or more of the cable interconnection routes and the total number of core nodes. They may also comprise bandwidth viability and/or connectivity for each core node.

In an embodiment the PON selection criteria comprise the total number of PONS for a said core node; and may also comprise one or a combination of: the number of network nodes; bandwidth validity; PON splitter configuration; equipment required; differential distance which is dependent on the respective cable interconnection routes used; power budget which is dependent on the respective cable interconnection routes used.

In an embodiment the apparatus is further arranged to allocate or receive with each exchange node representative data a splitter configuration type dependent on its distance from a respective core node, and a table of all permissible splitter configurations for the exchange nodes, the apparatus further arranged to use the table together with the splitter configuration type allocated to each exchange node within a PON combination to allocate a cost to said PON combination.

In an embodiment the apparatus is arranged to process the allocation of costs to each PON combination for a number of PON selection criteria in an order according to the speed of processing each PON selection criteria, and wherein performance of all PON selection criteria may be terminated for any one PON combination where this has already attracted a threshold high cost from previous PON selection criteria.

In an embodiment each respective allocated network node is represented in a first array and has an entry corresponding to a respective PON; each allocated network node is further represented in a second array and has an entry corresponding to a network or core node having the nearest splitter within the PON; each PON is represented in a third array and has an entry corresponding to a network or core node having the primary splitter for that PON; and wherein these entries are variables manipulated according to the respective heuristic search.

In an embodiment a first combination of core nodes is determined using a first core node criteria, and a second combination of core nodes is determined using a second core node criteria. The first core node criteria may include the node positions of existing network connection equipment to a higher order network such as a core network for connecting to a backhaul network formed by the PON design of the apparatus. Other criteria may include the bandwidth demand of a network node and its distances from a core network node for example. The second core node criteria may include total number of second core nodes (after having taken note of the first core nodes) and whether all network nodes are within a threshold distance of a core node.

There is also provided a method of building a PON based network for a plurality of network nodes having cable interconnections, the method comprising allocating a number of core nodes and PONS according to the following method:

determining a combination of core nodes from the network nodes, the core nodes being selected by allocating a combined cost to a series of core node combinations and selecting the lowest combined cost core node combination, the combined cost of each core node combination comprising a cost allocated for each of a number of core node selection criteria;

allocating a number of network nodes to each core node in the selected core node combination;

for each core node in the selected core node combination, determining a combination of PONS having respective cable interconnection routes for servicing the respective allocated nodes from the core node, the PONS being selected by allocating a combined cost to a series of PON combinations and selecting the lowest combined cost PON combination, the combined cost of each PON combination comprising a cost allocated to each PON within the respective combination for each of a number of PON selection criteria; and

coupling core node equipment at each core node to respective PON termination equipment at respective network nodes.

In another aspect the present invention provides a computer implemented method of designing a PON based network, the method comprising: receiving data representing a plurality of network nodes having cable interconnection routes; determining a combination of core nodes from the network nodes, the core nodes being selected by allocating a combined cost to a series of core node combinations and selecting the lowest combined cost core node combination, the combined cost of each core node combination comprising a cost allocated for each of a number of core node selection criteria. This method provides a number of core nodes which can be used as the head-end sites for a network of PONS to service the remaining network nodes. This provides a valid solution in terms of a number of PON related design criteria such as maximum length from a respective core node. The design of the individual PONS may be carried out manually or by other computer implemented methods.

A number of network nodes may be allocated to each core node in the core node combination selected by the above method. Heuristic searching together with the cost allocation to each node combination for various design factors can be used to make efficient use of computing resources and to provide a fast output.

In another aspect the present invention provides a method of designing a PON based network for a core node which is to serve a number of exchange nodes. The method determines a combination of PONS having respective cable interconnection routes for servicing the respective network nodes from the core node, the PONS being selected by allocating a combined cost to a series of PON combinations and selecting the lowest combined cost PON combination, the combined cost of each PON combination comprising a cost allocated to each PON within the respective combination for each of a number of PON selection criteria. This method can be applied to one or any number of core nodes, for example those selected by the above core selection method, or other methods including manual selection of core nodes.

### BRIEF DESCRIPTION OF THE DRAWINGS

Embodiments will now be described with reference to the following drawings, by way of example only and without intending to be limiting, in which:

FIG. 1 illustrates a typical passive optical network (PON);

FIG. 2 illustrates a typical backhaul optical network;

FIG. 3 illustrates a method flow chart for determining clusters of nodes according to an embodiment;

FIG. 4 illustrates selection of an additional core or primary aggregation node in the network of FIG. 3;

FIG. 5 illustrates an initial selection of further additional core or secondary aggregation nodes in the network of FIG. 5;

FIG. 6 illustrates the PON coverage of the network of FIG. 6;

FIGS. 7a, 7b, and 7c illustrate the search domains for the network of FIG. 6, an intermediate network, and the network of FIG. 8;

FIG. 8 illustrates a final selection of further additional core or secondary aggregation nodes according to the domain of FIG. 7c;

FIG. 9 illustrates the final clustering for the network using the secondary aggregation node allocations of FIG. 8 and the primary aggregation node selection of FIG. 4;

FIG. 10 illustrates an example cluster of exchange nodes showing node splitter configuration category;

FIG. 11 illustrates a method flow chart for designing PONS for a cluster of nodes according to an embodiment;

FIG. 12 illustrates various splitter configuration node categories;

FIG. 13 illustrates an initial solution of PONS for a cluster of nodes;

FIG. 14 illustrates a number of indexes used to represent possible PON solutions;

FIG. 15 illustrates a solution of PONS corresponding to the values in the indexes of FIG. 14;

FIG. 16 illustrates a number of PON splitter configurations;

FIG. 17 illustrates a table of possible PON splitter configurations;

FIG. 18 illustrates an example PON together with a compatible PON splitter configuration from the table of FIG. 17; and

FIG. 19 illustrates the PON splitter configuration of FIG. 18 together with a possible location for the splitters.

### DETAILED DESCRIPTION

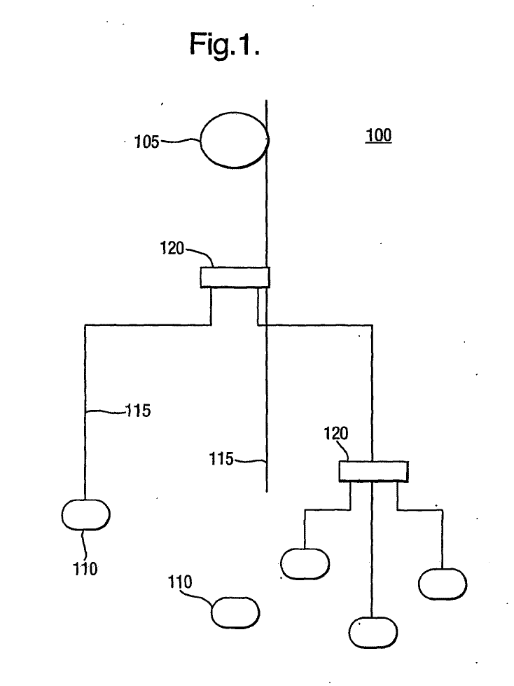

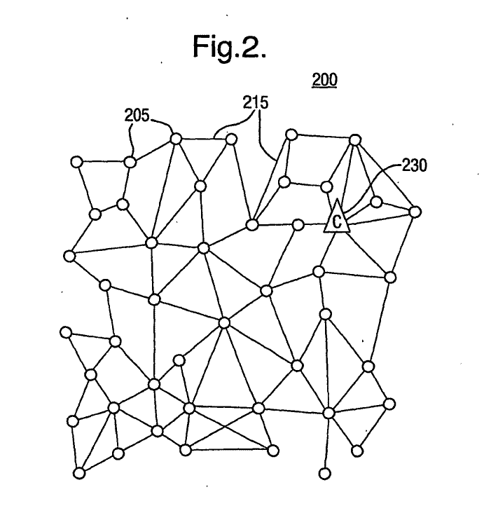

By way of background, FIG. 1 illustrates a passive optical network (PON). The PON 100 is an access network and has a head-end or exchange node 105 which is coupled to a larger backhaul network (200) shown in FIG. 2. The head-end node 105 is coupled to a number of end users or terminating equipment 110 by a number of optical fibre cables 115. Typically the network 100 is arranged in a tree structure given its peripheral nature, with the fibre being split by optical splitters 120 with individual downstream fibre runs going to different terminal equipment 110. Whilst splitting is an efficient manner in which to cover all of the terminating equipment nodes 110 from the one exchange node 105, the splitters reduce the light signal level down the split fibre runs and hence the range of these downstream fibre runs. In addition to splitters, each PON also requires optical line termination (OLT) equipment at the head-end node 105, and optical network units (ONU) equipment at each end-user node 110.

FIG. 2 shows a backhaul optical network for use in coupling a number of access networks (100) to a core or backbone network. The network 200 comprises a plurality of access head-end nodes 205 here referred to as exchange nodes, (providing access connectivity to the end customer by means of a variety of techniques, one of which could be an access PON (100)), and which are coupled to a core, metro or backbone network node 230 by a plurality of optical fibre cable runs 215. The core nodes 230 or points-of-presence form part of the core network (not shown) which may couple all of the backhaul networks 200 of a country or region together for example. Most of the exchange nodes 205 are coupled to the core node 230 via intermediate exchange nodes. Traditionally data communications in backhaul networks 200 has been achieved using direct optical links between each exchange node 205 and a core node 230, however given the size of the backhaul or outer core network in many regions or countries, and the need for carrier grade communications quality, this network architecture is expensive given its inherently low utilisation of fibre and network equipment. Other approaches use switching or grooming equipment at intermediate nodes 205 to aggregate the data traffic towards the core node 230, however this additional functionality is also expensive.

Given recent improvements in PON range or reach, it is now possible to deploy PONS in order to implement a backhaul network architecture. The use of PON technology in this backhaul network 200 would have a number of advantages including improved fibre utilisation and hence reduce cost. Recent advances in G.PON technology for example allow for distances of up to 60 km to be reached, and split ratios of up to 128. In addition G.PON systems now support up to 2.5 Gbits/s both upstream and downstream, and using the G.PON Encapsulation Mode (GEM) protocol, both data and time-division-multiplexed (TDM) traffic can be supported simultaneously on the same link. This allows G.PON, systems to effectively manage high bandwidth demand in the backhaul environment, where both data and TDM traffic are expected to co-exist for some time.

However the design and implementation of PONS in an existing backhaul network such as that shown in FIG. 2 is not a straight forward problem. Whilst manual design of individual PONS is possible, there exist a very large number of possible solutions given individual PON design constraints. It therefore seems impractical to obtain an optimised solution manually given the additional requirement to reduce cost, for example by minimising the number of PONS used. This is exacerbated for practical backhaul networks where thousands of exchange nodes 205 and hundreds of core nodes 230 may exist. It has been found for example that in the design of access networks, designs from individual designers can vary in cost by as much as 32% as planners attempted to satisfy the many design rules associated with the access network. Over a large area of such networks, for example over a country the size of the UK, this represents a significant additional cost or cost saving. Added to this the design of a backhaul network using PONS is significantly more complex than designing individual Greenfield access networks using PONS. This is because the optimum design of one PON in an area could result in poorer PON designs elsewhere, hence finding the optimal design for the entire area could be by means of the deployment of some PONs that are un-optimised in themselves, but contribute to a wider optimum solution. Furthermore, the number of PONS that must be designed in order to provide a backhaul network means that manual design would take considerable effort particularly if optimised designs are attempted.

An embodiment provides a two-part method for implementing a backhaul, outer core, or intermediate network design using an existing network infrastructure of fibre optical cable runs linking nodes such as cable intersections and network termination equipment locations. These nodes in a backhaul network represent exchange node locations (205) for respective access networks, as well as core nodes to which the exchange nodes are to be coupled. The method initially determines a number of core nodes required to cover or service all of the exchange node locations given PON design constraints, for example maximum distance. These core nodes can be located on the same site as a point-of-presence (230) for a core network for example, as well as additional network node locations which may be independently coupled to the original core nodes or core networks points-of-presence, or otherwise to the core network, for example using point-to-point fibre optic links or ring based optical or other high bandwidth technology. The method aims to provide an optimum (ie reduced) number of these core nodes which together are able to support all of the remaining network nodes by using clusters of network nodes each supported by PON technology from a core node. The second part of the method then designs an optimal PONS based coverage for each cluster of exchange nodes from a respective core node. For the purposes of this embodiment, network nodes which are not core nodes are referred to here as exchange nodes. However the methods of the embodiment could be applied to other network arrangements, for example where the non-core nodes or end nodes are not exchanges, but end consumers or street cabinets for example.

The determination of core nodes may be based initially on the location of points-of-presence locations, or based on other core node selection criteria such as physical location, customer proximity, business policy, and regulatory requirements. Other core nodes may be selected based on different core node selection criteria such as inherent bandwidth requirements and/or fibre connectivity—ie having a large number of connections to other network nodes. Still other core nodes may be selected according to cost—for example by minimising the overall number of nodes selected according to this criteria. The selection of core nodes may share certain selection criteria such as minimising overall or combined cost whilst meeting PON design constraints such as having all exchange nodes within a maximum distance of a core node.

In this embodiment, a first group or combination of core nodes is selected based on core network points-of-presence locations or node (230), a second combination of core nodes is selected based on a certain level of inherent bandwidth and fibre or cable connectivity, and a third group of core nodes are selected to ensure full PON coverage for all exchange nodes, whilst at the same time minimising the overall number of core nodes in order to reduce the combined cost of this or the complete core node combination. In alternative embodiments, only one group of core node selection criteria may be applied to all of the network nodes, for example where there are no existing points of presence.

In this embodiment the number of core nodes is minimised by effectively allocating a huge cost penalty associated with each one selected. Similarly penalty costs are associated with respect to other selection criteria such as not supporting all exchange nodes. The embodiment attempts to access all exchange nodes with the fewest core nodes (these core nodes being selected on a variety of factors) to form clusters of exchange nodes about each core node.

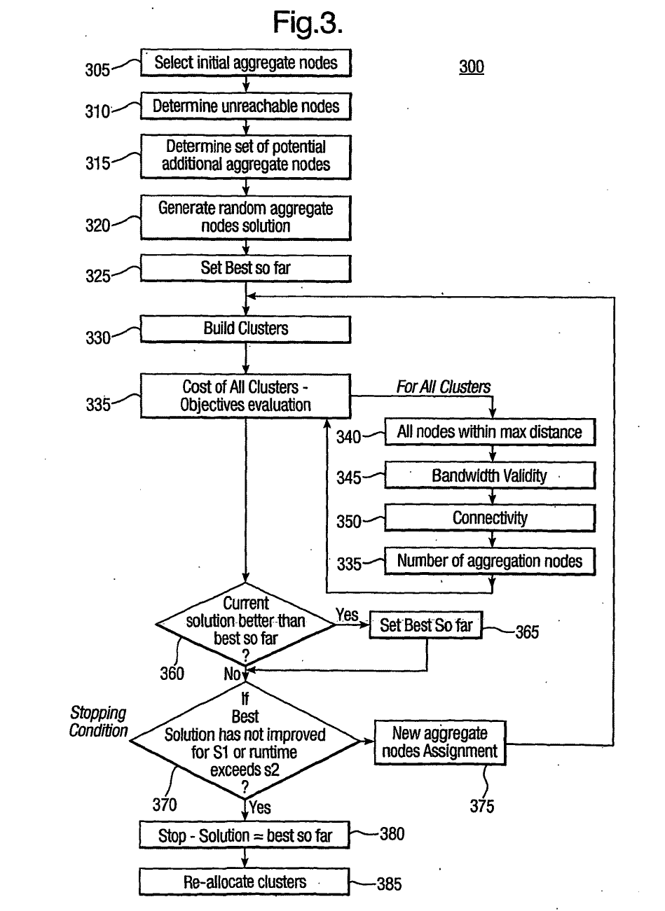

FIG. 3 illustrates of method of selecting or determining cores nodes for a backhaul network, and which each support a number of exchange nodes in order that all of the exchange nodes 205 are coupled to a core node using PON technology. Each PON has predetermined constraints or design criteria such as maximum fibre length from the exchange (based on known or estimated signal loss per fibre length characteristics), maximum differential distance (ratio of the distance from the core node to the most distant node and the core node to the closest node), maximum number of exchange nodes, maximum number of splitters to any one exchange node. In addition each PON must be able to support all of the (current or estimated future) bandwidth requirements of each node. These are termed here hard constraints which must be met for a valid design. There are also one or more soft constraints which should be to some extent optimised, and principle amongst these is reducing overall cost which is generally minimised by minimising the number of core nodes selected and minimising the overall number of PONS deployed.

For the purposes of selecting core nodes according to FIG. 3, the hard constraints include maximum fibre length from a core node, and a connectivity greater than one—in other words each selected core node must be connected to two or more other exchange nodes and cannot be a peripheral node “on its own”. Soft constraints include minimising the number of core nodes, and selecting core nodes with high connectivity and intrinsic bandwidth. By selecting higher bandwidth nodes as the locations for core nodes this avoids the nodes becoming part of a PON supported at a different core node and which requires most or all of a single PON to support its bandwidth demands—this is not an efficient way of allocating PON resources. In addition, a network node having high intrinsic bandwidth demand implies that these nodes will have larger premises/or space for subsequent placement of WDM (say) equipment for the interconnection of this node with the other core nodes.

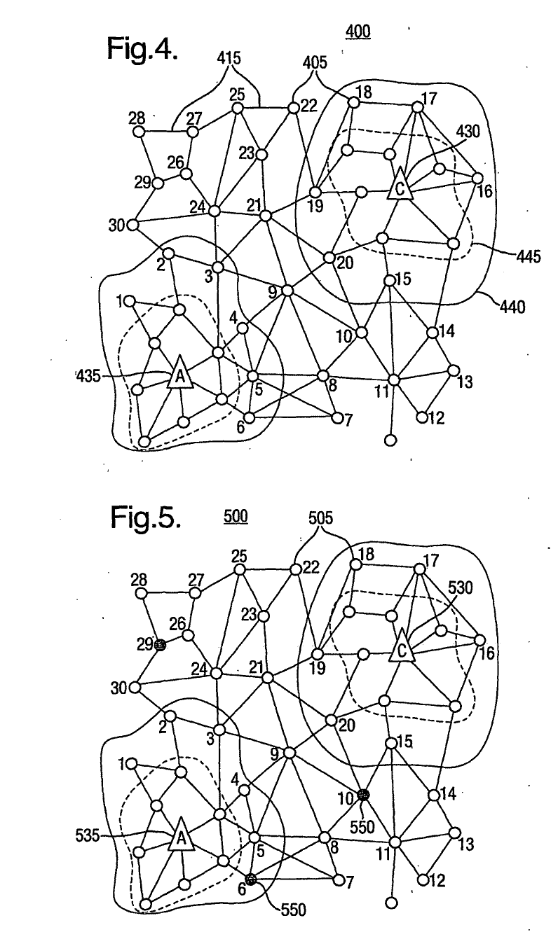

Referring to FIG. 3, the method (300) effectively searches various core node combinations or solutions and identifies ones which meet the hard constraints (eg doesn't exceed maximum fibre length to any exchange node) and selects the identified solution which optimises the soft constraints (typically lowest cost). Given the number of possible solutions or combinations of core nodes serving PONS in a practical backhaul network and currently available computing resources, the embodiment uses a heuristic search method such as simulated annealing, TABU search, or local guided searching in order to select an optimum solution, though not necessarily the most optimum solution from the entire search space in a reasonable time. Initially the method (300) selects an initial set of core nodes (305) from the exchange nodes 205. These are selected based on being a threshold minimum distance from any previously selected core nodes 230 (for example points-of-presence) and having a threshold bandwidth. The distance between each exchange node and each core node can be determined using the fibre run or path distances between each exchange node 205 and selecting the shortest path to the nearest core node 230. For example, given a power budget of say 22 dB for the PON and the power loss per km of fibre say 0.3 dB and the fact that at a minimum a 1×4 splitter will be used which has a lowest power loss say 7.3 dB; this gives a maximum distance ((22 −7.3)/0.3 km=49 km) for which an exchange can be distant from a metro node and still remain valid In this embodiment the threshold bandwidth is 80% of the bandwidth of a G.PON system (1.244 Gbits/s), thus if a network node consumes a bandwidth greater than this amount and is greater than the predetermined distance (eg 15 km) from the nearest core node already assigned because for example it is also a point-of-presence for a core network, then the network node is assigned as an additional core node—shown as 435 in FIG. 4. This approach avoids the problem of a single PON servicing a single exchange node due to the amount of bandwidth demanded.

Similarly if any exchange node has a bandwidth greater than the maximum permissible per PON then it is assigned as a core node. These core nodes 435 are selected according to different core node selection criteria than those core nodes 430 selected based purely on their co-location with a core network point-of-presence. The method (300) will then go on to select a further or third combination or group of core nodes based on different selection criteria including minimising cost as described further below.

FIG. 4 illustrates a backhaul network 400 having a number of exchange nodes 405 and a core node 430 selected according to a first core node selection criteria (points-of-presence locations), and which has been developed from the network 200 of FIG. 2 to include a further core node 435 selected according to a second core node selection criteria (inherent bandwidth and proximity to other core nodes). The exchange nodes 405 which can be supported by PON systems from the core nodes 430 or 435 are included within a maximum range region 440 radiating out from each core node 430 or 435. It can be seen that there are a number of exchange nodes 405 which cannot be reached (using the chosen PON technology) from these core nodes. All of these “unreachable” exchange nodes 405 which are outside the range regions 440 are potential additional core nodes. Additionally, peripheral exchange nodes within the range regions 440 of each already selected core node 430, 435 but outside a central region 445 associated with each core node 430, 435 can also be selected as further core nodes. These peripheral nodes are chosen in this embodiment as being 80-100% of the maximum range or fibre distance from their respective core node.

Thus the method (300) of FIG. 3, having selected an initial or further set of core nodes (305), then goes on to determine the unreachable exchange nodes (310). This is achieved by determining all exchange nodes 405 which are not within the maximum range of a core node. The method then determines a set of potential additional core nodes (315) which includes the unreachable nodes. This set also includes the peripheral nodes (those between lines 440 and 445) of each already selected core node 430, 435; that is those exchange nodes 405 which are within 80-100% of the maximum allowable PON fibre distance from their respective core node. This set of potential further nodes is numbered 1-30 in FIG. 4.

In an alternative embodiment the core nodes are all selected using the same selection criteria, in which case the initial core node selection (305) and determine unreachable nodes (310) steps will not be required. This may be the case where there are no points-of-presence to consider and no inherent bandwidth requirement issues. In this case all of the exchange or network nodes will be unreachable.

The method (300) then generates a random core node solution or combination of core nodes from the set of potential further core nodes (1-30) as an initial solution or core node combination for the heuristic search method used (320). An example initial random solution is illustrated in FIG. 5, which) shows three additional core nodes 550. The set of potential additional core nodes have been numbered 1-30, and it can be seen that the initially selected additional core nodes are exchange nodes 6, 10, and 29. Node 6 is a peripheral node of one of the previously selected core nodes (A) 535. Nodes 10 and 29 are “unreachable” from either of the previously selected core nodes 530 or 535. The method (300) then proceeds to search through various combinations of core nodes 550 from the set of potential core nodes (1-30) looking for a core node combination which meets the hard constraints such as can provide PON coverage to all of the unreachable nodes and optimises soft constraints such as minimising the number of secondary aggregation nodes used and maximising their connectivity.

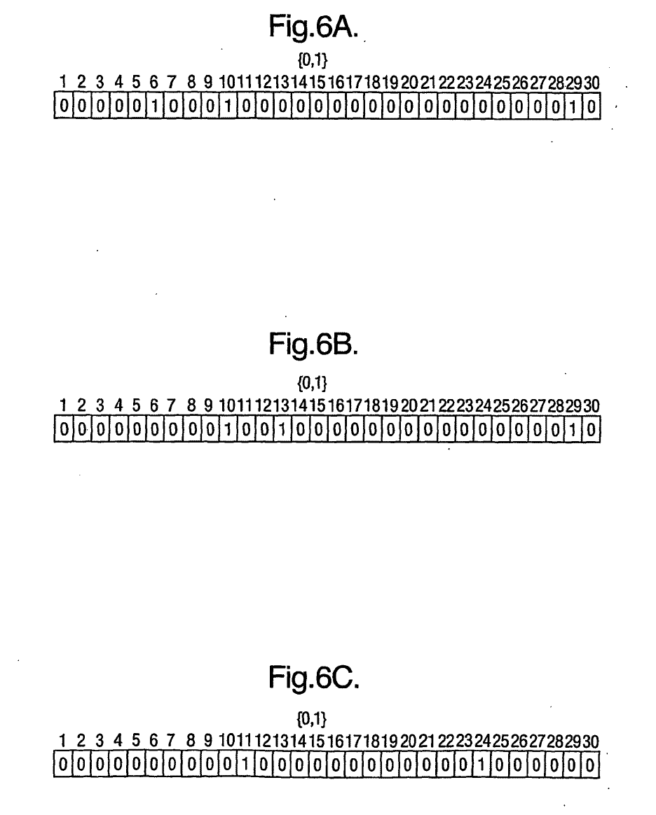

Numerous heuristic, search methods can be implemented as will be appreciated by those skilled in the art, including for example simulated annealing or local guided search methods. Similarly various methods of implementing these search methods with respect to this problem will be available to those skilled in the art. In an embodiment an array or domain is used as illustrated in FIG. 6. FIG. 6a shows the domain for the initial random solution of FIG. 5 with selected nodes (6, 10, and 29) having a “1” and non-selected nodes having a “0”. The method (300) is then able to change these values according to the heuristic search method and search parameters chosen in order to search the search space for a good solution or combination of core nodes. Whilst a detailed description of heuristic search methods is beyond the scope of this specification, a brief overview description is given to aid understanding. As will be appreciated by those skilled in the art, the heuristic search “system” moves from one solution (in this case one combination of core nodes) to another solution if the new solution is within a range of being better or worse than the current solution. An objective measure or cost for each solution is calculated according to the search design, with various factors attracting costs; for example number of core nodes in the solution, are all unreachable exchange nodes now covered by the selected core nodes and so on. Rather than disallowing solutions which don't meet all of the hard constraints such as covering all unreachable nodes, the method assigns them a high value or penalty cost when the aim is to minimise the overall or combined cost. Thus it may be possible for the search system to move to a worse solution which doesn't cover all the unreachable nodes for example. By allowing the system to move to a worse solution, the method avoids getting “trapped” in local optima, and therefore allows the search system to examine more of the search space. Typically the range of objective values which the search method will allow the system to move to will initially be fairly wide, but narrow over time so that towards the end of the search the system may only move to new solutions which are offer an improvement in objective value.

FIG. 6b shows a further solution having nodes 10, 13, and 29 as secondary aggregation nodes. For each new solution to which the search system moves, the method will determine an objective cost, and if the objective cost is within the current range of better or worse than the objective value of the current solution, the system will move to the new solution. The potential moves (ie before calculation of the objective cost and determination of whether to make the move) can be made in various ways as will be appreciated by those skilled in the art, for example a random number of the nodes in the domain may have their values changed, or incrementally one node may be changed at a time then the new solution's objective value determined and so on.

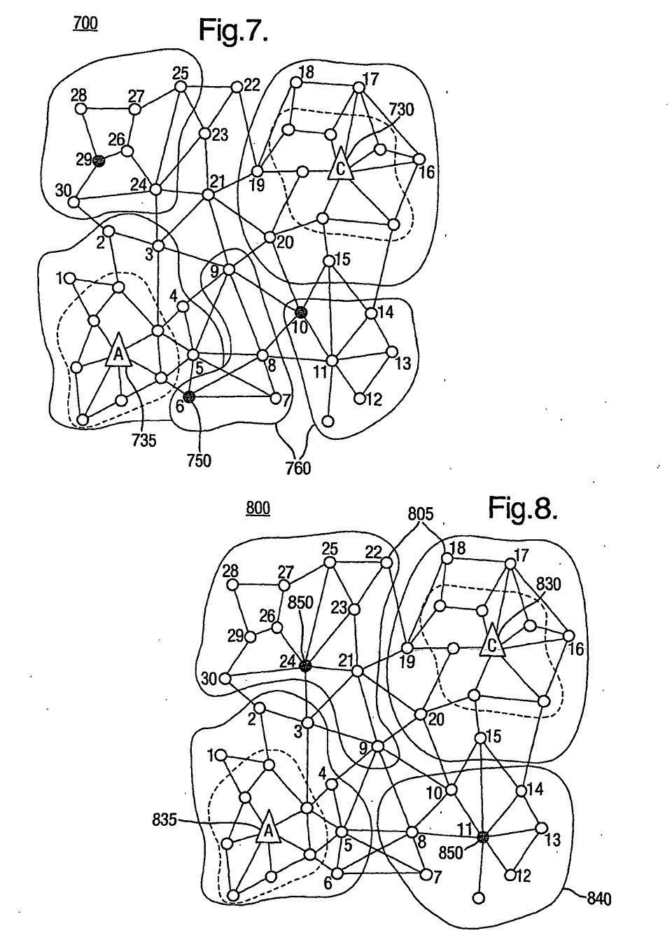

Returning to FIG. 3, the method (300) sets a parameter called here “Best so far” with the initial random solution of core nodes (325) illustrated in FIGS. 5 and 6a. The method then builds clusters of nodes from each of the secondary aggregation nodes 550 in the current solution (330). In this embodiment, this step simply comprises determining which exchange nodes 505 are within the maximum PON distance from the proposed core node 550 and allocating them to the cluster associated with that node 550. FIG. 7 illustrates the clusters 760 which can be formed from the core node 750 allocation of FIG. 5. It can be seen that not all unreachable nodes (21, 22, 23) can be reached from these additional core nodes 750. The method (330) determines an objective value or combined cost for the current solution or core node combination (335) of clusters 760. This objective value or combined cost is affected by whether all unreachable nodes are within one of the clusters 760 (340), and the method assigns a large penalty value or cost to the combined cost if they are not. The method also determines whether each core node in the current solution has high intrinsic bandwidth (a good or low score if this is the case) (345) and whether each core node in the current solution has high connectivity (350)—again a good or low value is given if this is the case, however a high or penalty value or cost is added to the objective value or combined cost for each core node which doesn't have this characteristic. The method also determines whether a high or low number of additional core nodes have been used in the solution (355), and assigns lower values to lower numbers. It can be seen therefore that a low objective value or combined cost represents a better solution in this embodiment.

Once an objective value or combined cost has been determined for each cluster 760, and these values added together to form an objective value or combined cost for the entire solution or core node combination (355), the method determines whether the current solution is better than the “best so far” (360), in other words whether the objective value of the current solution is better (lower in this embodiment) than the objective value of the solution stored in the “best so far” variable. If the current solution is better (350Y), the “best so far” variable is reset with the current solution, and the method moves on to determine whether the “best so far” variable has changed recently (370)—this is a stopping condition. If the current solution is not better (350N), the method moves straight to the stopping condition (370). In the stopping condition step (370), the method determines whether the best solution (best so far) has not improved for S1 seconds, or whether the runtime of the method has exceeded S2 seconds. That the solution has not improved for a while indicates that the search has found a local optimum solution which is better than any other solution found since. Typical values for S1 and S2 are S1=120 seconds and S2=2 days.

If a stopping condition has not been reached (370N), then a new core node combination or solution is determined (375). The new solution is determined by the heuristic search method chosen for the embodiment which manipulates the array or domain of node allocations in order to access a series of core node combinations or solutions. For example if the current solution has an objective cost within a range of better or worse than the previous solution, then the system will generate a new solution from the current solution according to the “move” constraints or parameters (decision variables) of the heuristic search being used. If not, then the system will generate a new solution from the previous solution using those same “move” constraints. A further example solution is shown in FIG. 6b. The method then returns to the build clusters (330) and determine objective value (335) steps. This process continues until the stopping condition has been reached (370Y). The search process then stops and the method then indicates or stores the best solution detected (380) which corresponds to the “best so far” variable.

A good solution is illustrated in FIG. 8 which shows just two additional core nodes 850 (11 and 24) selected according to the core node selection criteria of steps 340, 345, 350 and 355. Between them, this core node combination covers all of the “unreachable” exchange nodes (1-30). This solution corresponds to the domain shown in FIG. 6c. Whilst we can't be certain that this is the best solution given the size of the search space and the nature of heuristic searching, it represents a good low-cost solution which covers all of the unreachable nodes and which is achievable within a workable time frame. A systematic search of all possible solutions in a practical network may take many years to complete given currently available computing resources.

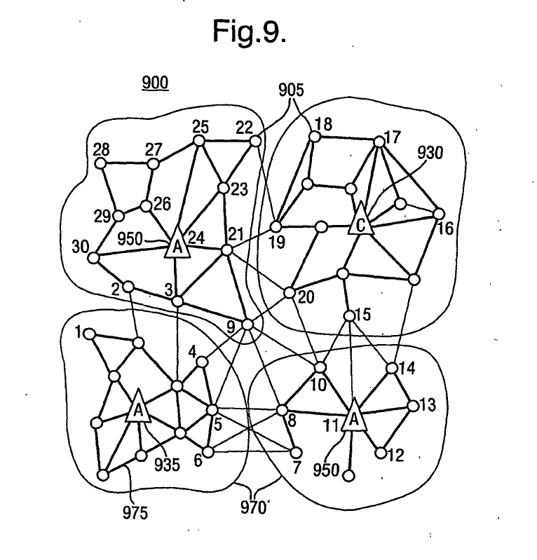

A further step (385) can be taken in which the exchange nodes 805 are reallocated amongst the pre-selected core nodes 830, 835 and the newly selected additional core nodes 850, according to which is closer. This is illustrated in FIG. 9 which shows a backhaul network in which each exchange node is supported using PON technology by its nearest core node (930, 935, 959). Thicker lines 975 indicate fibre runs which can be used within each cluster 970 supported by one of the core nodes (930, 935, 950). This process (385) produces a better distribution of nodes to be supported by the PON technology. Alternatively however, different allocations may be used, for example the original allocations used to determined whether all unreachable nodes were supported by a proposed core node may be maintained.

Once the core nodes 930, 935, 950 have been selected and the clustering or allocation of network or exchange nodes 905 determined, an optimal arrangement of PONS supporting each of the exchange nodes within each cluster 970 from each respective core node 930, 935 or 950 can then be determined. This optimum solution for each cluster 970 must meet hard constraints associated with PON design, as well as soft constraints, primarily reduced cost. Again a heuristic search method is used in order to find a good, though not necessarily the best, solution within a reasonable amount of time. Similarly costs are allocated for each of a number of selection criteria.

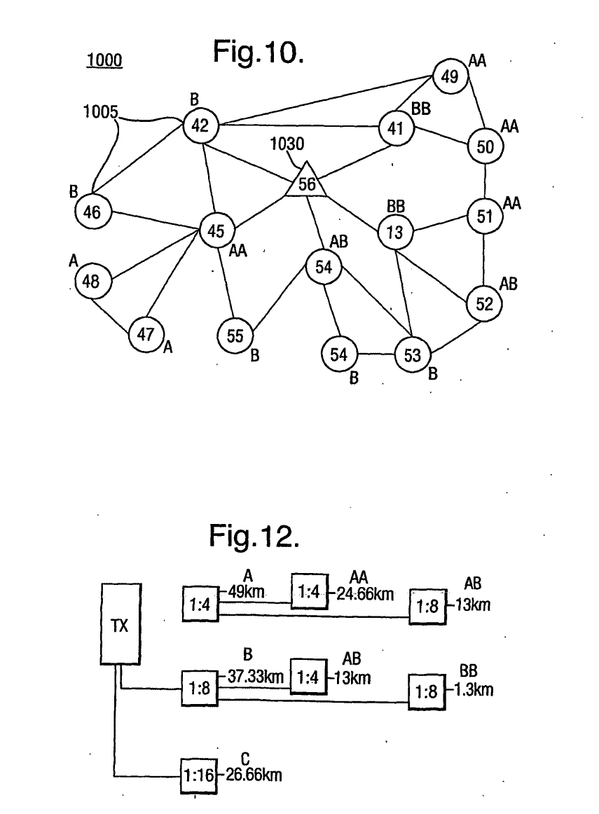

FIG. 10 illustrates an example cluster 1000 of exchange nodes 1005 with fibre links 1015 from a core node 1030 obtained from the above described core node selection and clustering or exchange node allocation method (300). The various nodes 1005, 1030 are labelled 41-56 (16 in total). The combinations of PONS used to support each of the exchange nodes 1005 from the core node 1030 should provide a low cost solution and meet predetermined design rules including for example a maximum number of nodes per PON, adequate bandwidth provision, maximum number of splitters, valid splitter configurations, maximum distance to nodes and differential distance. Typically the main parameters which drive down the cost of PON deployment are the number of PON systems deployed—due to the high cost of PON optical line termination equipment—and the amount of fibre resources used. Reduction of fibre can be achieved with appropriate selection of primary and secondary splitters, though these have a cost associated with them and so an optimal balance between reduced fibre use and splitter use is sought.

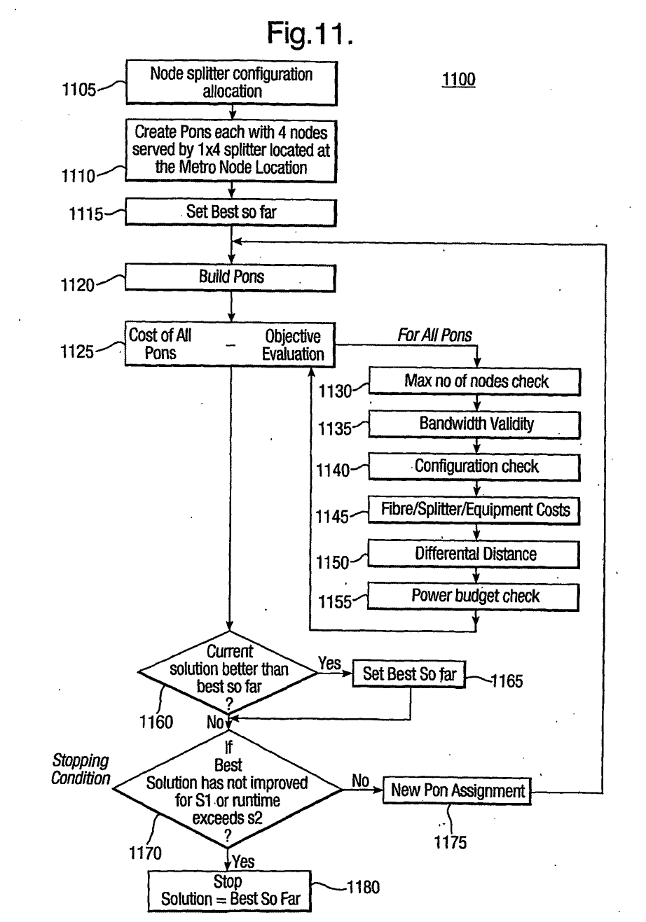

FIG. 11 illustrates a method according to an embodiment for determining a number of PON designs for a cluster of exchange nodes 1005 all supported from a central core or aggregation node 1030. The method (1100) is then repeated for each cluster determined from the clustering method described above—FIG. 3. The method (1100) initially determines the permissible splitter configurations for each exchange node (1105). Various splitter types are available for PON design, however each introduces different levels of signal loss. This means for example that a distant node with a consequently high signal loss due to fibre attenuation may only be able to be supported from a low loss splitter, whereas a close node may be supported by one high loss splitter or two (a primary and a secondary) low loss splitters for example. The higher the split number (eg 1:32) the higher the signal loss when compared with a low loss splitter (eg 1:4). Typically available GPON splitters include 1:4, 1:8, and 1:16.

FIG. 12 illustrates a range of splitter configuration categories that can be applied to exchange nodes depending on their distance from a respective core node. The distances shown on this diagram are illustrative only and relate to an overall PON power budget of 22 dB and specific power losses due to splitters and fibre; and the actual distances will be different for different PON power budgets and/or different signal loss figures due to splitter and fibre attenuation. The splitter configurations are defined in terms of the splitter configurations which can be used to support a given exchange node given the power budget available from the core node and its distance from the core node. The categories assigned to the nodes indicate the worst case splitter configuration in terms of dB loss that is suitable for the node given the core nodes power budget and the fibre distance from the core node. A category A node which is between 49 km and 37.33 km from the core node can only be served by a 1×4 primary splitter, however a category B node (37.33-26.33 km) can be served by either a 1×4 or a 1×8 (worst case) primary splitter. A category AA node (26.33-24.66 km) can be connected to a 1×4 secondary splitter in turn fed from a 1×4 primary splitter, and could also be fed by higher order splitter configuration categories such as A, B, or C (1×16 primary splitter). Similarly a category AB node has a worst case 1×8 secondary splitter fed from a 1×4 primary splitter or a 1×4 secondary splitter fed from a 1×8 primary, but could also be serviced by AA, C, B, or A category arrangements. A BB category node can be connected to a 1×8 secondary splitter fed from a 1×8 primary splitter in a worst case scenario. The method therefore determines the worst case splitter category for each exchange node 1005 in the cluster.

For example consider an exchange node 41 km from the core node. Assuming the attenuation of the fibre to be 0.3 dB/km, this equates to a 12.3 dB loss. If the power budget of the GPON system is 22 dB, then there is 22 dB-12.3 dB (=9.7 dB) allowable budget for the inclusion of splitters. Therefore this exchange node can be serviced by the core node using a GPON system, provided that any splitter combination prior to accessing this node does not exceed 9.7 dB. The dB loss of a 1×4 splitter is 7.3 dB and a 1×8 splitter 10.3 dB; therefore this exchange node can only be served by direct connection to a 1×4 primary splitter—category A node. In another example a node is 22 km from the core node; giving a fibre loss of 6.6 dB. This leaves 15.4 dB available for splitter losses which means the exchange node could be served by a 1×4 or 1×8 primary splitter, and could also (worst case) be served by a 1×4 primary splitter connected to a 1×4 secondary splitter (14.6 dB cumulative splitter loss). However this exchange node could not be serviced via a 1×8 secondary splitter connected to a 1×4 primary splitter as the cumulative splitter losses would be 18.1 dB. This exchange node is therefore category AA. The categories of the exchange nodes 1005 in FIG. 10 are indicated adjacent the respective node. These are used later in the method (1100) as a shortcut mechanism for checking the validity of certain PON solutions as will be described in more detail below.

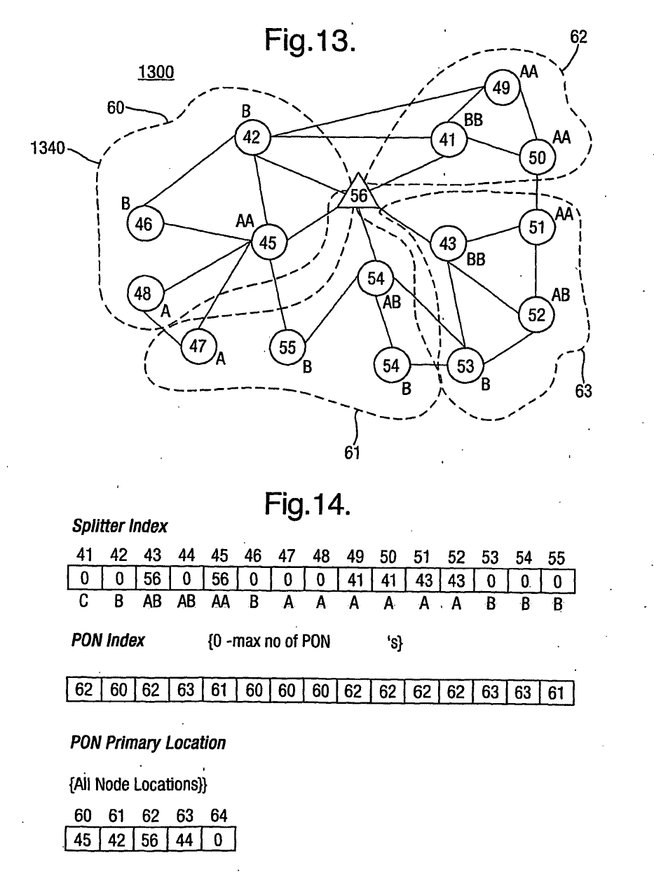

Returning to FIG. 11, the method (1100) then creates an initial PON solution for the cluster (1110). This is an initial solution comprising a number of PONS to support all of the exchange nodes 1005 of the cluster from the core node 1030, and which is used as a seed for the heuristic searching method to be used to find an optimal PONS solution. The heuristic search method then goes on to generate a series of PON combinations which are then assessed by the method according to the various PON selection criteria as described below. Whilst a random initial solution or PON combination could be generated, in order to improve the search results and time taken, a “reasonable” predetermined solution is chosen—in this embodiment each PON comprises up to 4 nodes and is served by a 1×4 primary splitter from the core node location. This solution is illustrated in FIG. 13 which shows the cluster of nodes of FIG. 10 with nodes allocated to PONS 1340 with 4 (3 for the last PON) exchange nodes each. The PONS are labelled 60-63. Other good initial solutions will be known to those skilled in the art and these could alternatively be used. This initial solution is then set as the “best so far” (1115).

In an embodiment the search parameters representing the various PON designs tested are provided in three arrays or domains as illustrated in FIG. 14. The set of arrays or indexes comprise a splitter index having an entry for each of the exchange nodes 1005 (41-55), which represents to which splitter location the node is connected. An assigned value of 0 in the splitter index indicates that the node is connected directly to the primary splitter designated for this PON. Other values indicate that the node is connected to a secondary at the indicated position, thereby allowing for splitters at a variety of places. Thus for example nodes 41, 42, 44, 46, 47, 48, 53, 54 and 55 are connected directly to a respective primary splitter, whereas node 9 is connected to a secondary splitter located at node 41, and node 45 is connected to a secondary splitter at node 56—the core node. The splitter index also includes the splitter category of each node—for example category A, B, AA, AB, and BB.

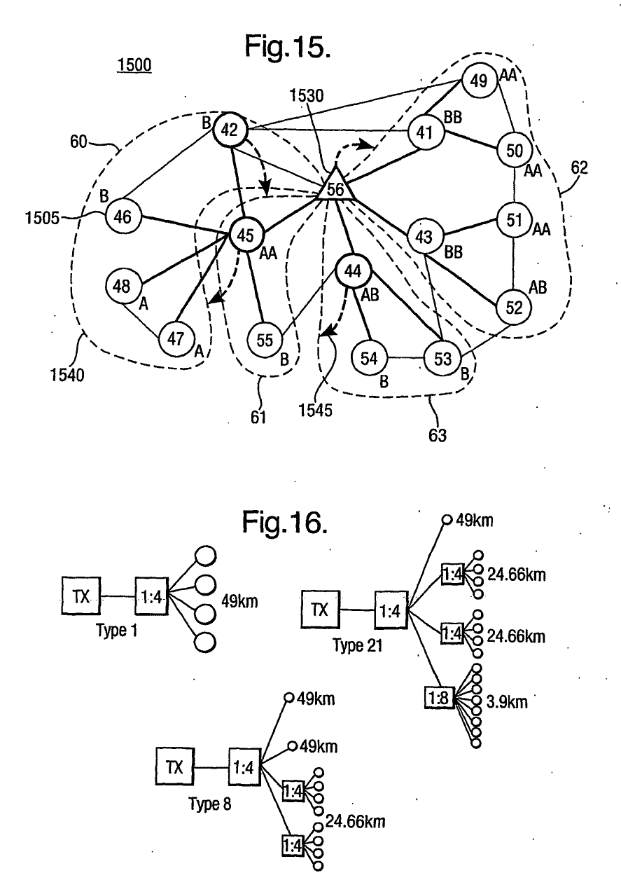

The PON index assigns nodes to specific PONS; assignments with the same value indicate these exchange nodes belonging to the same PON. The value itself is an index into the PON primary location index, which indicates the node location of the primary splitter for that PON. Thus for example exchange node 41 is assigned to PON 62 (see PON index) which has a primary splitter at node 56 (see PON primary index for PON 62)—the core node. Similarly exchange node 45 is assigned to PON 61, and has a primary splitter at exchange node 42 (and a secondary splitter at node 56). The various values of the indices shown in FIG. 14 correspond with the allocation of PONS in FIG. 15. The locations of primary splitters are indicated in FIG. 15 with bold lines about the corresponding node symbol together with a dashed bold arrow 1545 to the corresponding PON group 1540. It can be seen straight away that the second example (PON 61) will not produce an optimal PON design given that a fibre run is required from node 56 (the core node) to node 42 to get to the primary splitter at node 42, and another fibre run is required to get back to node 56 to the secondary splitter, and from their further fibre runs are required to reach nodes 45 and 55. Of course it will not always be so obvious which PON designs are sub-optimal and which are optimal, and the method (1100) determines an objective value or combined cost for each solution or PON combination that the heuristic search method used generates.

As will be well known to those skilled in the art, various search methods could be used, for example simulated annealing, TABU, or local guided searching; and each will create new search moves (changes in one or more of the three indexes) according to its own internal structure and various operational parameters or decision variables. The solution encoding used in this embodiment—the three indexes shown in FIG. 14—allow a number of changes to the current solution to be easily made, including: for a specific PON the best location for the primary can be determined by a single move; nodes can be easily assigned/swapped between PONS; and nodes can be easily assigned to different secondary/primary locations. This together with the method of evaluation used below allows clearly invalid designs to be quickly “rejected” without having to perform more complex evaluations as described in more detail below.

Referring back to FIG. 11, the method (1100) then builds the PONS using the values in the splitter index, the PON index, and the PON primary Location index (1120). Given the allocation of decision variables, exchange nodes are assigned to PONS, and consequent fibre runs are determined from their respective location and the location of the PONS splitter(s) in order to build a topology structure which represents each PON. These structures or arrangements are then interrogated for costs and validity.

The method (1100) determines the combined cost or an objective value for the combinations of allocated PONS in the cluster (1125) by determining the costs or objective value for each of the PONS in the cluster individually, then combining these costs. For each PON, the method (1100) assesses the current PON design against a number of PON selection criteria. Initially the method determines whether the current PON design meets the “maximum number of nodes” PON design criteria (1130). The PON being evaluated will be allocated a cost or value depending on the number of nodes it has, with a low cost being given to a range of reasonable numbers such as 4-6, a high cost to a very low number such as 1 or 2 which is undesirable, and a very high or penalty cost to numbers of nodes which exceed the maximum allowed by PON design criteria. The method (1100) may also be configured to stop assessing a particular PON or a cluster of PONS if it carries a high penalty cost indicating that at least one of the PONS are not a valid design. The method may simply then proceed directly to the cost comparison step (1160) with the high penalty cost in order for the current solution to be rejected quickly and the method to move on to test another solution. When the evaluation steps (1130-1150) are arranged in order of speed to perform, invalid cluster or PON designs can be quickly rejected in order to avoid evaluating these PON or clusters according to more complex criteria. This improves overall evaluation efficiency; however the evaluation steps can in principle be performed in any order.

After evaluating (and optionally being able to reject) the number of nodes of a PON solution, the method (1100) evaluates the bandwidth of the current PON (1135). Assuming for the sake of explanation only a maximum bandwidth of 1244 Mbits per wavelength, and 3 wavelengths, the maximum bandwidth per PON is 3732 Mbit/s. If the combined demand from the exchange nodes allocated to the current PON exceeds this, the PON attracts a high penalty cost, or is rejected as described above. Similarly a very low bandwidth demand may indicate a sub-optimal PON design and so this will attract a high cost, whereas a bandwidth demand within a threshold range will attract a low cost.

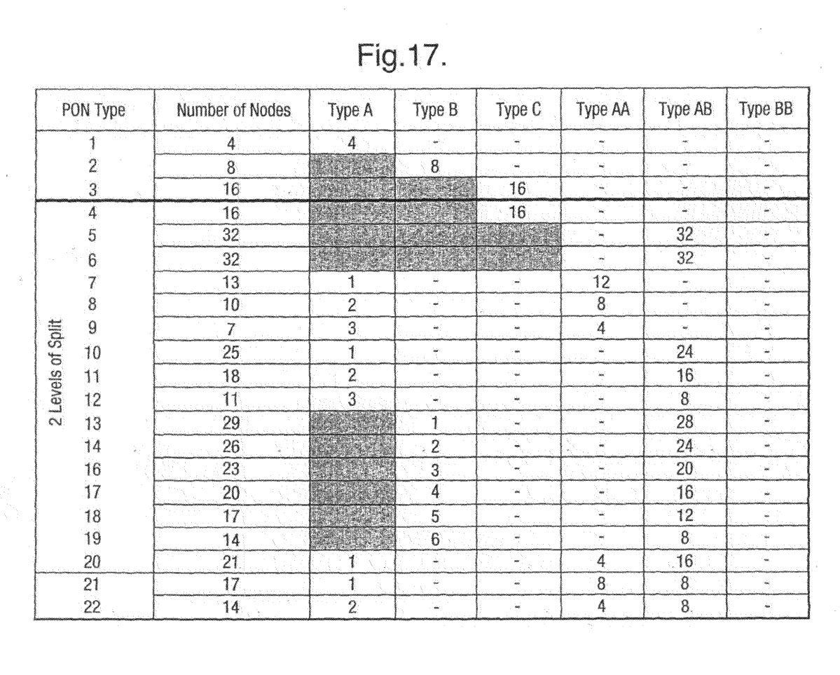

The method (1100) then moves on to evaluate the configuration of the PON design (1140); in other words whether the deployment of the primary and secondary (if any) splitters used for this particular PON design is valid given the splitter configuration categories (A, B, AA, AB, BB) of each of the exchange nodes. As noted previously, signal loss occurs due to fibre distance from the core node and splitting of the signal. It can therefore be determined whether the current PON design meets the requirements of the various exchange nodes in terms of allowable signal loss. As noted previously, FIG. 12 shows the ranges in terms of fibre length and splitter options for each category of exchange node. Given the range of available splitter types, maximum level of split and the associated distance constraints, there exists a set of all possible PON splitter configurations. FIG. 16 illustrates some possible PON splitter configurations and resultant reach. The type 1 configuration comprises a 1×4 splitter and 4 exchange nodes up to 49 km from the core node. This splitter configuration would be suitable for category A nodes, or higher (ie B, C, AA, AB, BB). That is, it can be used for very distant exchange nodes (eg A) but also to support close-in nodes (eg AB). The type 8 splitter configuration comprises a 1×4 primary splitter and two 1×4 secondary splitters. This would be suitable for at least two type A (distant) nodes, and up to eight type AA (closer) nodes. The type 21 splitter configuration has a 1×4 primary splitter, two 1×4 secondary splitters, and one 1×8 secondary splitter. This would be suitable for one type A node, up to eight type AA nodes, and up to eight type AB nodes. A set of possible PON configurations given the splitter mix and distance considerations can then be determined, as illustrated by the table of FIG. 17. This table can be produced and/or loaded by the method at an early stage (for example step 1105), and then used to quickly check whether a suitable splitter configuration exists that can serve the current PON solution. If not, the PON design is allocated a high cost for this evaluation step (1140), or rejected early as noted above.

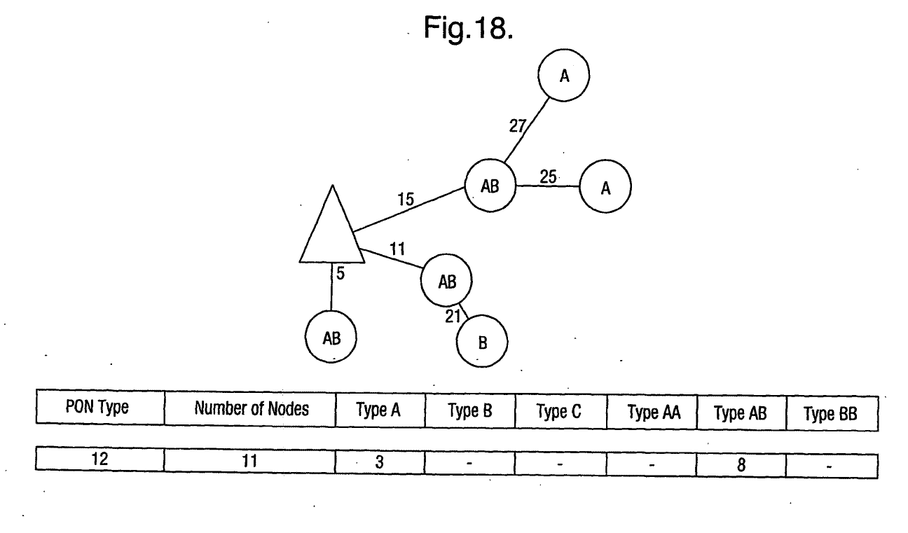

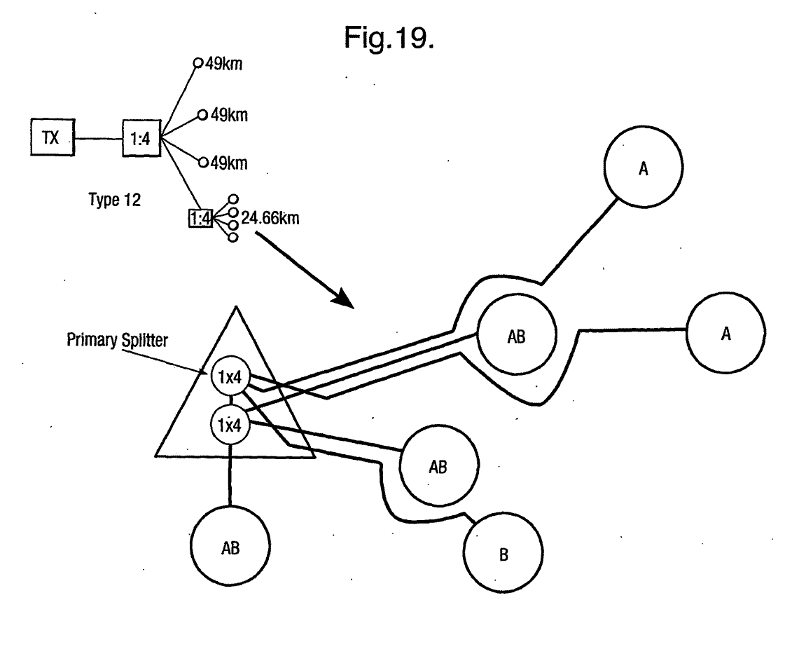

This configuration check process (1140) is illustrated in more detail with reference to FIG. 18 which illustrates an example PON node allocation. Each line connecting an exchange node represents a fibre length with an associated distance in km, and each exchange node has an associated allowable splitter configuration category (eg AB) as indicated. The PON has two type A nodes, one type B nodes, and three type AB nodes. Looking down the table of FIG. 17, it can be seen that these can be accommodated by a type 12 splitter configuration which supports up to three type A nodes and up to eight type AB nodes. Given that a type B node can be covered by a type A and type AB (see FIG. 12), this configuration can support the PON design of FIG. 18. A generic type 12 splitter configuration is illustrated in FIG. 19, and a possible implementation with primary and secondary splitter locations is also illustrated.

By way of comparison, a type 9 splitter configuration cannot support the given PON design because although this can support up to three type A nodes and so would support the two type A and one type B nodes of the PON of FIG. 18, it only provides for 4 type AA nodes and cannot support the current PONS (three) type AB nodes. Because the current solution can be supported by a splitter configuration in the table (FIG. 17), it can be allocated a low cost for this evaluation step (1140). Furthermore the use of this predetermined table speeds up the assessment of each PON design for this PON selection criteria as only a simple matching operation is required for each evaluation.

The table (FIG. 17) also shows, for example, that if a PON had five category A nodes allocated (ie more than 37.33 km from the metro node but no more than 49 km), then no suitable PON configuration exists that could possibly feed all these nodes off a single PON. In this case, this solution can be dismissed or given a large penalty cost or score.

At this point, the method (1100) may determine whether the combined costs from evaluation steps (1130, 1135, 1140) exceed a threshold due to penalty costs for being an invalid solution in one or more ways, and if so the remaining evaluation steps can be skipped as described above in order to avoid unnecessary processing time. Alternatively this step may be performed after each of the above evaluation steps. The method (1100) then determines the actual or estimated cost of the parts or PON equipment required to build a PON according to the current design (1145), including for example the fibre cost, splitter cost, and the head-end (OLT) and user termination (ONU) equipment costs. These costs can be stored in a suitable database and updated as required; and the method may even be configured to query a third party supplier's database for current prices.

The method then determines the differential distance for the current PON design (1150). The differential distance is the distance between the path length represented by the exchange node 1005 closest to the serving core node 1030, and that at the greatest distance from the core node. This differential distance must be below or equal to a predefined distance; for example in GPON design this might be 37 kn. A differential distance which exceeds the maximum predefined distance attracts a penalty cost, whereas a low cost is allocated to a solution with a differential distance well below this limit.

Finally the method (1100) determines whether the current PON design meets a power budget constraint (1155). For each exchange node, the method checks whether the signal provided from the core node meets a minimum level given the signal losses due to fibre loss (0.3 dB/km) and splitter losses to that exchange node. If the losses are too high, the PON solution attracts a high cost, and this is repeated for each exchange node in the current PON design; the costs associated with each exchange node being added together to get the total cost for the current PON design.

The evaluation steps (1130-1155) are then repeated for each PON design in the current cluster of PON combinations or solutions, and the total or combined cost (if the solution hasn't already be rejected as described above) is determined using the costs allocated to each PON for each PON selection criteria. The method (1100) then determines whether the combined cost or objective value of the current solution or PON combination is better than the “best so far” solution (1160). If this is the case (1160Y), the “best so far” variable is set to the current solution with its associated combined cost (1165); and the method moves on to check the stopping condition (1170). If the current solution is not the best so far (1160N), then the method moves directly to check the stopping condition (1170). At the stopping condition step (1170), the method determines whether or not the best solution has improved within a given time (S1), or whether a runtime (S2) has been exceeded. Example stopping conditions include S1=30 sec and S2=1000 sec.

If a stopping condition has not been reached (1170N), the method (1100) moves on to reallocate the PON variables in the three indexes (1175) in order to represent a new cluster of PON designs (a new PON combination or solution) and in turn evaluate them against a number of PON selection criteria as previously described. The way in which the PON variables in the three indexes are varied depends on the heuristic search method selected and its preset operating parameters or decision variables. For example, if the current PON solution combined cost is not an improvement or within the current annealing schedule range of better or worse than the combined cost of the previous solution, then the method may be configured to make constrained movements in one, two, or all of the indexes from the previous solution. If however the current solution is better than the previous solution, then those same moves may be made from the current solution. Example moves include changing randomly selected entries of the or each index by a random or predetermined amount as will be understood by those skilled in the art. In this way the heuristic search method used generates a series of PON combinations or solutions which are evaluated against the PON selection criteria by allocating costs.

The method (1100) then returns to the building PONS step (1120) before again evaluating the current solution. If one of the stopping conditions has been met (1170Y), the method stops and outputs the cluster of PON designs associated with the best so far combined cost (1180). The method (1100) is then repeated for each cluster within the overall backhaul network.

The PON design method (1100) for each cluster can be repeated for different starting solutions (1110) in order to determine whether the same optimum solution is selected. If it is, then this gives a higher degree of confidence that the solution is not fortuitous—for example the result of a local optimum that the search got stuck on, but which doesn't represent a good solution in the context of the entire search space. Of course heuristic searches are designed to avoid this sort of phenomena, however this can not be guaranteed. The type of heurist search to be employed may depend on particular characteristics of the existing network structure (fibre links and node structures), and therefore a degree of experimentation may be required in order to identify an optimum search strategy for a particular network problem as is known.

The embodiment described therefore provides a method of designing a PON-based backhaul or other large mesh-type network using existing fibre links and node locations by first determining a number of clusters of exchange nodes each to be supported by a core node, then determining a number of PONS for each cluster in order to support all of the nodes in the network using PON technology. This two-part method provides an optimal (though not necessarily the most optimal) solution in a reasonable time. By allocating large penalty costs to invalid designs, the final solution can be “guaranteed” to be valid whilst at the same time allowing the heuristic search method to operate as intended by allowing moves to worse (eg invalid) solutions. Furthermore mistakes that can normally be made from manual designs can be avoided, such as missing a node or addressing the same node more than once.

Alternatively the clusters may be determined using the method of FIG. 3, and then the PON designs for each cluster determined in another way; for example manually. Similarly the clusters may be determined using another method, such as a manual determination, whilst the PON designs for the or each cluster can be determined using the method of FIG. 11. Similarly parts of the methods described above (eg 1100) could be used in the design of multiple access networks, in either a Greenfield (ic no existing infrastructure) or a Brownfield (existing fibre and node locations) scenario.

Whilst the embodiments have been described with respect to designing a backhaul network, other network types could alternatively be designed to be supported by PON technology; for example a scenario in which the end nodes are not exchanges but are, in fact street cabinets. Similarly the above described methods or suitable variations could be used to support direct linking of customers via fibre to a core node without any intervening cabinets or local exchanges. They could also be used where PON architectures are being deployed in Local area networks where the traffic is predominantly directly between the end user and the main switching centre. Further, whilst the PON designs have been described with respect to GPON technology, other types of PON network could be substituted, for example BPON and EPON.

Once the network has been designed, the PON head-end, end-user or termination and splitter equipment can be installed at the appropriate node locations, and the fibre links connected (and if necessary installed) according to the design. An embodiment may simply produce a paper plan or a plan displayed on a display screen illustrating where each part of the network should be positioned and how it should be connected, together with a list of parts, and the total cost. An embodiment may be arranged to process data representing node location and fibre links from one database and to output into another database data representing the core node locations, the determined clusters of exchange nodes, and the determined PON designs for each cluster. This data can then be used to install a backhaul or other network according to the data stored in this database.

All core nodes, regardless on the criterion use to select them will need to be interconnected. This interconnection is not discussed here as the technology will be dependent on the distances. bandwidth and protocols that are to be supported by such links as will be appreciated by those skilled in the art; however examples include SDH/Sonnet rings and WDM rings or direct links.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A computer implemented method of designing a PON based network, the method comprising:
receiving data representing a plurality of network nodes having cable interconnection routes;
determining a combination of core nodes from the network nodes, the core nodes being selected by allocating a combined cost to a series of core node combinations and selecting the lowest combined cost core node combination, the combined cost of each core node combination comprising a cost allocated for each of a number of core node selection criteria;
allocating a number of network nodes to each core node in the selected core node combination; for each core node in the selected core node combination, determining a combination of PONS having respective cable interconnection routes for servicing the respective allocated nodes from the core node, the PONS being selected by allocating a combined cost to a series of PON combinations and selecting the lowest combined cost PON combination, the combined cost of each PON combination comprising a cost allocated to each PON within the respective combination for each of a number of PON selection criteria; and
outputting data representing each of the lowest cost PON combinations.

2. A method according to claim 1, wherein the series of core node combinations and PON combinations are determined according to respective heuristic search algorithms applied to the respective total core node combinations and the total PON combinations for each core node.

3. A method according to claim 2, wherein the first core node combination in the respective series is a random combination of core nodes and wherein the first PON combination in the respective series for each core node comprises a number of predetermined PONS.

4. A method according to claim 1, wherein the core node selection criteria comprise the distance from each network node to a core node using one or more of the cable interconnection routes and the total number of core nodes.

5. A method according to claim 4, wherein the core node selection criteria further comprises bandwidth viability and/or connectivity for each core node.

6. A method according to claim 1, wherein the PON selection criteria comprise the total number of PONS for a said core node.

7. A method according to claim 6, wherein the PON criteria for each core node further comprises one or a combination of: the number of network nodes; bandwidth validity; PON splitter configuration; equipment required; differential distance which is dependent on the respective cable interconnection routes used; power budget which is dependent on the respective cable interconnection routes used.

8. A method according to claim 1, further comprising allocating each exchange node a splitter configuration type dependent on its distance from a respective core node, and generating a table of all permissible splitter configurations for the exchange nodes, and using the table together with the splitter configuration type allocated to each exchange node within a PON combination to allocate a cost to said PON combination.

9. A method according to claim 1, wherein the step of allocating costs to each PON combination for a number of PON selection criteria is performed in an order according to the speed of processing each PON selection criteria, and wherein performance of all PON selection criteria may be terminated for any one PON combination where this has already attracted a threshold high cost from previous PON selection criteria.

10. A method according to claim 1, wherein for each core node: each respective allocated network node is represented in a first array and has an entry corresponding to a respective PON; each allocated network node is further represented in a second array and has an entry corresponding to a network or core node having the nearest splitter within the PON; each PON is represented in a third array and has an entry corresponding to a network or core node having the primary splitter for that PON; and wherein these entries are variables manipulated according to the respective heuristic search.

11. A method according to claim 1, wherein a first combination of core nodes is determined using a first core node criteria, and wherein a second combination of core nodes is determined using a second core node criteria.

12. A method according to claim 11, wherein the first core node criteria comprise: existing core node locations, bandwidth threshold, distance from existing core node threshold; and wherein the second core node criteria comprise: distance from each network node to a core node, the total number of core nodes in the second combination of core nodes.

13. A method of building a PON based network for a plurality of network nodes having cable interconnections, the method comprising allocating a number of core nodes and PONS according to claim 1, and coupling core node equipment at each core node to respective PON termination equipment at respective network nodes.

14. A computer program product for carrying computer code arranged when executed on a computer to carry out a method according to claim 1.

15. Computer apparatus for designing a PON based network for a plurality pf network nodes having cable interconnection routes, the apparatus comprising:
means for determining a combination of core nodes from the network nodes, the core nodes being selected by allocating a combined cost to a series of core node combinations and selecting the lowest combined cost core node combination, the combined cost of each core node combination comprising a cost allocated for each of a number of core node criteria;
means for allocating a number of network nodes to each core node in the selected core node combination;
means for determining a combination of PONS for servicing the respective allocated network nodes to each respective selected core node, the PONS for each core node being selected by allocating a combined cost to a series of PON combinations and selecting the lowest combined cost PON combination, the combined cost of each PON combination comprising a cost allocated to each PON within the respective combination for each of a number of PON criteria.

16. Computer apparatus according to claim 1, further comprising:
means for receiving data representing the network nodes and the cable interconnection routes from a database;
means for outputting data representing each of the lowest cost PON combinations to a database.
